(19) United States
(12) Patent Application Publication
(10) Pub. No.: US 2005/0217760 A1
(43) Pub. Date: Oct. 6, 2005

(54) Magnetic recording medium, and method for producing the same

(75) Inventors: Yasushi Hattori, Kanagawa (JP); Koukichi Waki, Kanagawa (JP); Kenji Ichikawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/094,211

(22) Filed: Mar. 31, 2005

(30) Foreign Application Priority Data
Mar. 31, 2004 (JP) 2004-106431

(51) Int. Cl. H01F 41/00

(52) U.S. Cl. 148/105

(57) ABSTRACT

A magnetic recording medium including: a support; and a magnetic layer provided on the support, the magnetic layer containing a magnetic particle of a CuAu type or Cu₃Au type ferromagnetic ordered alloy phase, wherein a content of boron in the magnetic particle is 0 to 0.9 at %, and a content of fluorine in the magnetic particle is 0.09 to 0.3 at %. Also provided is a method for producing a magnetic recording medium including: forming an alloy particle capable of forming a CuAu type or Cu₃Au type ferromagnetic ordered alloy phase by a reduction method in which a reducing agent containing a boron atom is used; forming a layer including the alloy particle on a support; heat-treating the alloy particle at a temperature below a transformation temperature of the alloy particle; and annealing the alloy particle at a temperature which is not lower than the transformation temperature of the alloy particle.

### CROSS-REFERENCE TO RELATED APPLICATION

This application claims priority under 35 USC 119 from Japanese Patent Application No. 2004-106431, the disclosure of which is incorporated by reference herein.

### BACKGROUND OF THE INVENTION

1. Field of the Invention

The present invention relates to a magnetic recording medium having a magnetic layer containing magnetic particles of a CuAu type or Cu₃Au type ferromagnetic ordered alloy, and a method for producing the same.

2. Description of the Related Art

It is necessary to decrease the size of magnetic particles included in a magnetic layer in order to increase magnetic recording density. In magnetic recording media widely used as video tapes, computer tapes, disks and the like, noise decreases along with decrease in particle size when the mass of ferromagnetic body is the same.

A CuAu type or Cu₃Au type ferromagnetic ordered alloy is a material for the magnetic particles desirable for increasing magnetic recording density. (Refer to, for example, Japanese Patent Application Laid-Open (JP-A) No. 2003-73705.) The reason is that the ferromagnetic ordered alloy is known to have high crystal magnetic anisotropy because of strain generated at the time of ordering, and exhibits ferromagnetism even when the size of the magnetic particles is decreased.

When alloy particles which can form the CuAu type or Cu₃Au type ferromagnetic ordered alloy are produced, the resulting alloy particles have a face-centered cubic lattice structure and generally exhibit soft magnetism or ferromagnetism. In order to obtain a ferromagnetic ordered alloy having a coercive force of at least 95.5 kA/m (i.e., 1200 Oe) required for a magnetic recording medium, it is necessary to carry out annealing (heat treatment) at a temperature not lower than a transformation temperature at which a disordered phase is transformed to an ordered phase. Thus, lowering the transformation temperature is an important issue.

Addition of a third element is proposed as an effective process for lowering the transformation temperature. One example proposes addition of 1 to 30 at % of boron to a CuAu type ferromagnetic ordered alloy as a third element. (Refer to JP-A No. 2003-6830.) This fact also means that the transformation temperature lowers when boron is present in the alloy in an amount of at least 1 at %.

When NaBH₄ is used as a reducing agent in a process in which the alloy particles forming the CuAu type or Cu₃Au type ferromagnetic ordered alloy are synthesized in a solution, it is not certain whether boron is included in the resulting alloy particles, but it is highly likely that boron is mixed in a magnetic layer as an impurity. When boron is mixed in the alloy particles forming the CuAu type or Cu₃Au type ferromagnetic ordered alloy in an amount of 1 at % or more during annealing, it may also be considered from the fact disclosed in JP-A No. 2003-6830 that the transformation temperature lowers, and coercive force may increase at the same annealing temperature. In this case, boron is unintentionally mixed in the magnetic layer as an impurity and is not always mixed in the alloy particles during annealing. Therefore, boron is considered to be a possible factor for variations in magnetic property. Thus, the content of boron in the alloy particles needs to be reduced to below 1 at % in order to suppress variations in the magnetic property.

NaBH₄ is favorably used as a reducing agent because it is inexpensive and has suitable reducing power for obtaining the alloy particles forming the CuAu type or Cu₃Au type ferromagnetic ordered alloy. However, because of the above facts, NaBH₄ may unintentionally lower the transformation temperature when used as a reducing agent. Accordingly, when NaBH₄ is used as a reducing agent, a certain process needs to be carried out so as to reduce the boron content (as an impurity) in the alloy particles to less than 1 at %.

### SUMMARY OF THE INVENTION

The present invention has been devised, considering the above-described conventional problems.

An aspect of the invention provides a magnetic recording medium comprising a support and a magnetic layer provided on the support. The magnetic layer includes a magnetic particle of a CuAu type or Cu₃Au type ferromagnetic ordered alloy phase. The content of boron atom in the magnetic particle is 0 to 0.9 at %, and the content of fluorine atom in the magnetic particle is 0.09 to 0.3 at %. The magnetic particle may have been reduced by using NaBH₄.

Another aspect of the invention provides a method for producing a magnetic recording medium. The method comprises:
forming an alloy particle capable of forming a CuAu type or Cu₃Au type ferromagnetic ordered alloy phase by a reduction method in which a reducing agent containing a boron atom is used;
forming a layer including the alloy particle on a support;
heat-treating the alloy particle at a temperature below a transformation temperature of the alloy particle; and
annealing the alloy particle at a temperature which is not lower than the transformation temperature of the alloy particle.

The annealing and the heat-treatment can be each independently before of after the formation of the layer including the alloy particle provided that the annealing is conducted after the heat-treatment.

### DESCRIPTION OF THE PRESENT INVENTION

First, a method for producing a magnetic recording medium of the present invention will be described below.

<<Method for Producing Magnetic Recording Medium>>

The method of the invention for producing a magnetic recording medium comprises:
forming an alloy particle capable of forming a CuAu type or Cu₃Au type ferromagnetic ordered alloy phase by a reduction method in which a reducing agent containing a boron atom is used;
forming a layer including the alloy particle on a support;
heat-treating the alloy particle at a temperature below a transformation temperature of the alloy particle; and
annealing the alloy particle at a temperature which is not lower than the transformation temperature of the alloy particle, wherein the annealing and the heat-treatment are each independently before of after the formation of the layer including the alloy particle provided that the annealing is conducted after the heat-treatment. First, the production of the alloy particle will now be described.
   <Preparation of Alloy Particle>

Alloy particles which can be converted to magnetic particles by annealing can be produced by a vapor phase method or a liquid phase method. Considering suitability for mass production, the liquid phase method is used in the present invention. While a variety of conventionally known methods can be used as the liquid phase method, a reduction method, which is an improvement of the conventional method, is used in the present invention. Among reduction methods, a reverse micelle method by which the particle size can be easily controlled is particularly preferable.

(Reverse Micelle Method)

The reverse micelle method comprises mixing two types of reverse micelle solutions to conduct a reductive reaction, and maturing the resulting solution at a predetermined temperature after the reductive reaction. Each process will be described below.

Reductive Reaction

First, a water-insoluble organic solvent containing a surfactant is mixed with an aqueous reducing agent solution to prepare a reverse micelle solution (I).

An oil-soluble surfactant is used as the surfactant. Specific examples thereof include sulfonates (e.g., AEROSOL OT produced by Wako Pure Chemical Industries, Ltd.), quaternary ammonium salts (e.g., cetyltrimethylammonium bromide), and ethers (e.g., pentaethylene glycol dodecyl ether). The amount of the surfactant in the water-insoluble organic solvent is preferably 20 to 200 g/l.

Preferable examples of the water-insoluble organic solvent dissolving the surfactant include alkanes, ethers, and alcohols.

An alkane having 7 to 12 carbon atoms is preferable as the water-insoluble organic solvent. Specifically, heptane, octane, isooctane, nonane, decane, undecane and dodecane are preferable. Diethyl ether, dipropyl ether, and dibutyl ether are included in preferable examples of ethers usable as the water-insoluble organic solvent. Ethoxyethanol and ethoxypropanol are also included in preferable examples of alcohols usable as the water-insoluble organic solvent.

In the present invention, as the reducing agent in the aqueous reducing agent solution, a reducing agent containing boron atoms, preferably a compound containing BH₄⁻, may be used alone or in combination with compounds selected from: alcohols; polyalcohols; H₂; HCHO; and compounds containing S₂O₆²⁻, H₂PO₂⁻, N₂H₅⁺, H₂PO₃⁻, and the like. The compound containing BH₄⁻ is preferable as the reducing agent containing boron atoms, and preferable examples thereof include NaBH₄, LiBH₄ and KBH₄. The amount of the reducing agent in the aqueous solution is 3 to 50 mol based on 1 mol of metal salt.

The mass ratio of water to the surfactant (water/surfactant) in the reverse micelle solution (I) is preferably 20 or lower. When the mass ratio exceeds 20, precipitation easily occurs and the particles tend to be uneven. The mass ratio is preferably 15 or lower and more preferably 0.5 to 10.

Besides the above micelle solution (I), a reverse micelle solution (II) is prepared by mixing a water-insoluble organic solvent containing a surfactant with an aqueous metal salt solution.

The conditions of the surfactant and the water-insoluble organic solvent (e.g., materials to be used, concentrations, and the like) are the same as in the case of the reverse micelle solution (I).

The components of the reverse micelle solution (II) may be similar to or different from, the components of the reverse micelle solution (I). Further, the mass ratio range of water to the surfactant in the reverse micelle solution (II) may be the same as that in the reverse micelle solution (I), and the mass ratio may be the same as or different from that in the case of the reverse micelle solution (I).

As the metal salt contained in the aqueous metal salt solution, it is preferable to select a proper metal salt such that the magnetic particles to be produced can form a CuAu type or Cu₃Au type ferromagnetic ordered alloy.

Examples of the CuAu type ferromagnetic ordered alloy include FeNi, FePd, FePt, CoPt, and CoAu. Preferable among these are FePd, FePt, and CoPt.

Examples of the Cu₃Au type ferromagnetic ordered alloy include Ni₃Fe, FePd₃, Fe₃Pt, FePt₃, CoPt₃, Ni₃Pt, CrPt₃, and Ni₃Mn. Preferable among these are FePd₃, FePt₃, CoPt₃, Fe₃Pd, Fe₃Pt, and CO₃Pt.

Specific examples of the metal salt include H₂PtCl₆, K₂PtCl₄, Pt(CH₃COCHCOCH₃)₂, Na₂PdCl₄, Pd(OCOCH₃)₂, PdCl₂, Pd(CH₃COCHCOCH₃)₂, HAuCl₄, Fe₂(SO₄)₃, Fe(NO₃)₃, (NH₄)₃Fe(C₂O₄)₃, Fe(CH₃COCHCOCH₃)₃, NiSO₄, CoCl₂, and Co(OCOCH₃)₂.

The concentration of the aqueous metal salt solution (as the metal salt concentration) is preferably 0.1 to 1000 μmol/ml and more preferably 1 to 100 μmol/ml.

By appropriately selecting the metal salt, an alloy particle capable of forming the CuAu type or Cu₃Au type ferromagnetic ordered alloy in which a base metal and a noble metal are alloyed is produced.

The alloy phase of the alloy particles needs to be transformed from the disordered phase to the ordered phase by annealing the alloy particles, which will be described later. In order to lower the transformation temperature, it is preferable to add a third element such as Sb, Pb, Bi, Cu, Ag, Zn, or In to the foregoing binary alloys. Precursors of the respective third elements are preferably added to the metal salt solution in advance. The amount of the third elements to be added is preferably 1 to 30 at %, and more preferably 5 to 20 at %, based on the binary alloys.

The reverse micelle solutions (I) and (II) prepared as described above are mixed. Although the mixing method is not particularly limited, in view of uniformity of reduction, mixing is preferably carried out by adding the reverse micelle solution (II) to the reverse micelle solution (I) while stirring the reverse micelle solution (I). A reductive reaction is conducted after the completion of the mixing. The temperature during the reduction is preferably a constant temperature within a range of −5 to 30° C.

When the reduction temperature is lower than −5C, a problem arises in that the water phase freezes, thereby resulting in an uneven reductive reaction. When the reduction temperature exceeds 30° C., flocculation or precipitation easily occurs, thereby making the system unstable. The reduction temperature is preferably 0 to 25° C. and more preferably 5 to 25C.

The foregoing term “constant temperature” means that, when the preset temperature is T(° C.), the real temperature falls in a range of T±3° C. The upper limit and the lower limit of the real reduction temperature have to be within the above-mentioned range of the temperature (−5 to 30° C.).

Although the duration of the reduction should be properly set depending on the amounts or the like of the reverse micelle solutions, the duration is preferably 1 to 30 minutes and more preferably 5 to 20 minutes.

Since the reduction greatly affects the monodispersibility of the particle diameter distribution, it is preferable to carry out the reduction with stirring at a rate as high as possible.

A preferable stirring apparatus may be a stirring apparatus having high shearing force, and may be specifically a stirring apparatus in which: the stirring blade basically has a turbine type or paddle type structure; a sharp edge is attached to the end of the blade or a position where it is in contact with the blade; and the blade is rotated by a motor. Specifically, Dissolver (manufactured by Tokushu Kika Kogyo Co., Ltd.), Omnimixer (manufactured by Yamato Scientific Co., Ltd.), Homogenizer (manufactured by SMT), and the like are useful. By using such an apparatus, monodispersed alloy particles can be produced in the form of a stable dispersion in a liquid.

It is preferable to add at least one dispersant having 1 to 3 groups selected from amino groups and carboxyl groups to at least one of the above reverse micelle solutions (I) and (II) in an amount of 0.001 to 10 mol per mol of the alloy particles to be produced. The term “mol of an alloy” or “mol of alloy particles” refers to an amount of the alloy or alloy particles containing 1 mol of constituent atoms.

Addition of such a dispersant makes it possible to obtain alloy particles with improved monodispersion property which are free from flocculation.

When the amount of the dispersant is less than 0.001 mol, the monodispersibility of the alloy particles may not be improved. When the amount of the dispersant exceeds 10 mol, flocculation may occur.

As the aforementioned dispersant, an organic compound having a group adsorbable to the surface of the alloy particle is preferable. Specific examples of the dispersant include organic compounds having 1 to 3 groups selected from amino groups, carboxyl groups, sulfonic acid groups and sulfinic acid groups. Only a single dispersant may be used, or two or more dispersants may be used in combination.

The compound may have a structural formula represented by R—NH₂, NH₂—R—NH₂, NH₂—R(NH₂)—NH₂, R—COOH, COOH—R—COOH, COOH—R(COOH)—COOH, R—SO₃H, SO₃H—R—SO₃H, SO₃H—R(SO₃H)—SO₃H, R—SO₂H, SO₂H—R—SO₂H, or SO₂H—R(SO₂H)—SO₂H, wherein R is a linear, branched or cyclic, saturated or unsaturated hydrocarbon.

Oleic acid is particularly preferable as the dispersant. Oleic acid is a surfactant well known for stabilizing colloids and has been used to protect metal particles of iron or the like. Oleic acid has a relatively long chain (for example, oleic acid has a chain of 18 carbons with a length of up to 20 Å (about 2 nm) and is not an aliphatic compound but has one double bond) which gives important steric hindrance counteracting a strong magnetic interaction between the particles.

In the same way as in the case of oleic acid, similar long-chain carboxylic acids such as erucic acid and linoleic acid may be used. The long-chain carboxylic acids may be long-chain organic acids having 8 to 22 carbon atoms. In an embodiment, only a single kind of such a long-chain carboxylic acid is used. In another embodiment, two or more kinds of such long-chain carboxylic acids are used in combination. Oleic acid (e.g., olive oil) is preferable because it is an easily available and inexpensive natural resource. As well as oleic acid, oleylamine derived from oleic acid is also a useful dispersant.

In the above reductive reaction, it is considered that a metal with a lower redox potential (metal with a redox potential of about −0.2 V (vs. N.H.E (Normal Hydrogen Electrode)) or lower) such as Co, Fe, Ni, or Cr in the CuAu type or Cu₃Au type ferromagnetic ordered alloy phase is reduced by a reducing agent and deposited in a micro-sized and monodisperse state. Thereafter, in a heating stage and in a maturing step which will be described later, the base metal which has precipitated becomes a core and, on the surface thereof, a metal with a higher redox potential (metal with a redox potential of about 0.2 V (vs. N.H.E) or higher) such as Pt, Pd, or Rh is reduced by the base metal and deposited, thereby replacing the base metal. The ionized base metal is considered to be reduced again by the reducing agent and deposited. Such a process is repeated to obtain an alloy particle capable of forming the CuAu type or Cu₃Au type ferromagnetic ordered alloy.

(2) Maturation

After the completion of the reductive reaction, the solution after the reaction is heated to a maturation temperature.

The maturation temperature is preferably maintained at a constant temperature which is higher than the temperature in the reductive reaction and which is in a range of 30 to 90° C. The maturation time is preferably 5 to 180 minutes. When the maturation temperature is higher than the above range or the maturation time is longer than the above range, flocculation or precipitation easily occurs. On the contrary, when the temperature is lower than the above range or the time is shorter than the above range, the reaction may not be completed, leading to a change in the composition of the alloy. The maturation temperature is preferably 40 to 80° C. and more preferably 40 to 70° C. The maturation time is preferably 10 to 150 minutes and more preferably 20 to 120 minutes.

The aforementioned term “constant temperature” has the same meaning as in the case of the temperature in the reductive reaction (wherein the term “reducing temperature” in the above-described definition is replaced with “maturation temperature”). Particularly, the maturation temperature is higher than the temperature at the reductive reaction by preferably 5C or larger, and more preferably 10° C. or larger provided the maturation temperature is within the aforementioned maturation temperature range (30 to 90° C.). When the difference between the reduction temperature and the maturation temperature is smaller than 5° C., a composition according to the formulation may not be obtained.

In the aforementioned maturation, a precious metal deposits on the base metal which has been reduced and deposited in the reductive reaction.

Namely, the precious metal is reduced only on the base metal, and therefore, the base metal and the precious metal do not deposit separately. Thus, alloy particles which can efficiently form the CuAu type or Cu₃Au type ferromagnetic ordered alloy can be produced in a high yield according to the formulated composition ratio, and the composition of the alloy particles can be controlled as desired. Further, the diameter of the resulting alloy particles can be controlled as desired by appropriately adjusting the temperature and stirring speed at the maturation.

In an embodiment, after the maturation, the solution after the maturation is washed with a mixed solution of water and a primary alcohol and then precipitation treatment is carried out using a primary alcohol to produce a precipitate, which is then dispersed in an organic solvent. Impurities are removed in this embodiment, thereby improving the coatability at the time of forming a magnetic layer of the magnetic recording medium by coating. The above washing and the dispersing are respectively carried out at least once and preferably twice or more.

Although there is no particular limitation on the primary alcohol used in the washing step, methanol, ethanol, or the like is preferable. The mixing ratio by volume (water/primary alcohol) is preferably in a range of 10/1 to 2/1 and more preferably in a range of 5/1 to 3/1. If the proportion of water is high, it may be difficult to remove the surfactant. On the contrary, if the proportion of the primary alcohol is high, flocculation may occur.

The alloy particles dispersed in the solution (i.e., alloy-particle-containing solution) are obtained in the above manner. Since the alloy particles have monodisperse distribution, even when these particles are applied onto a support, they do not flocculate but remain in a uniformly dispersed state. These alloy particles do not flocculate even when annealing treatment is carried out, and ferromagnetism can be efficiently imparted to the alloy particles, and the alloy particles have excellent coating property.

The diameter of the alloy particles before the after-described oxidation, is preferably small in order to reduce noise. If the diameter is too small, however, the particles may become superparamagnetic after annealing, which is unsuitable for use in magnetic recording. Generally, the diameter of the alloy particle is preferably 1 to 100 nm, more preferably 1 to 20 nm, further prefrably 3 to 10 nm.

(Reduction Method)

There are a variety of methods for producing the alloy particles that can form the CuAu type or Cu₃Au type ferromagnetic ordered alloy. A method is preferable in which a metal with a lower redox potential (which may simply be referred to as a “base metal” hereinafter) and a metal with a higher redox potential (which may simply be referred to as a “precious metal” hereinafter) are reduced with a reducing agent or the like in an organic solvent, water, or a mixed solution of an organic solvent and water.

The sequence of the reduction of the base metal and the reduction of the precious metal is not particularly limited, and both may be reduced simultaneously.

As the organic solvent, alcohol, polyalcohol, or the like can be used. Examples of the alcohol include methanol, ethanol, and butanol, and examples of the polyalcohol include ethylene glycol and glycerin. Examples of the CuAu type or Cu₃Au type ferromagnetic ordered alloy are the same as in the above description of the reverse micelle method.

Further, a method disclosed in paragraphs 18 to 30 in JP-A No. 2003-073705 (the disclosure of which is incorporated herein by reference) can be applied as a method for producing alloy particles by depositing the precious metal before the deposition of the base metal.

Pt, Pd, or Rh is preferably used as the metal with a higher redox potential, and H₂PtCl₆.6H₂O, Pt(CH₃COCHCOCH₃)₂, RhCl₃.3H₂O, Pd(OCOCH₃)₂, PdCl₂, Pd(CH₃COCHCOCH₃)₂, or the like can be used in the form of a solution. The concentration of the metal in the solution is preferably 0.1 to 1000 μmol/ml and more preferably 0.1 to 100 μmol/ml.

Co, Fe, Ni, or Cr is preferably used as the metal with a lower redox potential, and Fe and Co are particularly preferable. These metals can be used by dissolving FeSO₄.7H₂O, NiSO₄.7H₂O, CoCl₂.6H₂O, Co(OCOCH₃)₂.4H₂O, or the like in a solvent. The concentration of the metal in a solution is preferably 0.1 to 1000 μmol/ml and more preferably 0.1 to 100 μmol/ml.

Similarly to the above-described reverse micelle method, the transformation temperature at which the alloy transforms to the ferromagnetic ordered alloy is preferably lowered by adding a third element to a binary alloy. The amount of the third element(s) to be added may be in the ranges mentioned in the above description of the reverse micelle method.

For example, when a base metal and a precious metal are reduced and deposited in this order by using a reducing agent, the reduction is preferably carried out as follows: the base material is reduced with, or the base metal and a part of the precious metal are reduced with, a reducing agent having a reduction potential lower than −0.2 V (vs. N.H.E), the resultant reaction system is added to a precious metal source, the precious metal is reduced with a reducing agent having a redox potential higher than −0.2 V (vs. N.H.E), and thereafter, the base metal is reduced with a reducing agent having a reduction potential lower than −0.2 V (vs. N.H.E).

Although the redox potential varies depending on the pH of the system, the reducing agent with a redox potential higher than −0.2 V (vs. N.H.E) is preferably an alcohol such as 1,2-hexadecanediol, a glycerin, H₂, or HCHO.

In the present invention, a reducing agent containing boron, preferably a compound containing BH₄⁻, may be used as the reducing agent with a redox potential lower than −0.2 V (vs. N.H.E). The reducing agent may be used together with a compound containing S₂O₆²⁻, H₂PO₂⁻, N₂H₅⁺ or H₂PO₃⁻. No reducing agent is particularly required when a zero-valent metal compound such as Fe carbonyl is used as a raw material of the base metal.

The alloy particles can be stably produced in the presence of an adsorbent at the time of reducing and depositing the precious metal. A polymer or a surfactant is preferably used as the adsorbent. Examples of the polymer include polyvinyl alcohol (PVA), poly-N-vinyl-2-pyrrolidone (PVP), and gelatin. PVP is particularly preferable.

The molecular weight of the polymer is preferably 20,000 to 60,000 and more preferably 30,000 to 50,000. The amount by mass of the polymer is preferably 0.1 to 10 times and more preferably 0.1 to 5 times the mass of the alloy particles to be produced.

The surfactant as the adsorbent preferably contains an “organic stabilizer”, which is a long chain organic compound represented by a formula R-X. In the formula, R represents a “tail group”, which is a linear or branched hydrocarbon or fluorocarbon chain and generally contains 8 to 22 carbon atoms. X represents a “head group”, which is a portion (X) providing a specific chemical bond to the surface of the alloy particle and is preferably selected from the group consisting of sulfinate (—SOOH), sulfonate (—SO₂OH), phosphinate (—POOH), phosphonate (—OPO(OH)₂), carboxylate, and thiol.

The organic stabilizer is preferably selected from the group consisting of sulfonic acids (R—SO₂OH), sulfinic acids (R—SOOH), phosphinic acids (R₂POOH), phosphonic acids (R—OPO(OH)₂), carboxylic acids (R—COOH), and thiols (R—SH). As in the reverse micelle method, oleic acid is particularly preferable.

The combination of the phosphine and the organic stabilizer (e.g., a combination of triorganophosphine and an acid) can provide excellent controllability to the growth and stabilization of the particles. While didecyl ether and didodecyl ether can be used, phenyl ether or n-octyl ether is preferably used as the solvent because of its low cost and high boiling point.

The reaction is carried out at a temperature of 80 to 360° C. and more preferably 80 to 240° C., depending on the desired alloy particles and the boiling point of the solvent. The particles may not grow if the temperature is lower than the range. If the temperature is higher than the range, the particles may grow without control, thereby increasing the amount of undesirable by-products.

Similarly to the reverse micelle method, the particle diameter of the alloy particle is preferably 1 to 100 nm, more preferably 3 to 20 nm, and particularly preferably 3 to 10 nm.

A seed crystal method is effective as a method for increasing the particle size (particle diameter). When the alloy particles are used in a magnetic recording medium, it is preferable to achieve close-packing of the alloy particles in order to increase the recording capacity. For that purpose, the standard deviation of the size of the alloy particles is preferably less than 10%, and more preferably 5% or less. The variation coefficient of the particle size is preferably less than 10%, and more preferably 5% or less.

When the particle size is too small, the alloy particles are superparamagnetic, which is not preferable. In order to increase the particle size, as described above, the seed crystal method is preferably used. In this method, a metal having a redox potential higher than that of the metal forming the particles may deposit, leading to oxidation of the particles. Therefore, the particles are preferably subjected to hydrogenation treatment in advance.

The outermost layer of the alloy particle is preferably formed by a precious metal from the standpoint of preventing oxidation. However, the particles having such a structure easily flocculate. Therefore, according to the present invention, the outermost layer of the particle is preferably formed by an alloy of a precious metal and a base metal. Such a structure can be easily and efficiently formed by the liquid phase method.

Removal of salts from the solution after the production of the alloy particles is preferable in terms of improvement in the dispersion stability of the alloy particles. In order to remove the salts, in an embodiment, an excessive amount of an alcohol is added to cause slight flocculation, then the flocculate is allowed to precipitate spontaneously or by centrifugation such that the salts are removed together with the supernatant. However, since flocculation easily occurs in such a method, the salt is preferably removed by an ultrafiltration method.

In this way, alloy particles dispersed in a solution (alloy-particle-containing solution) are obtained.

A transmission electron microscope (TEM) may be used in the measurement of the particle diameter of the alloy particles. Although electronic diffraction by the TEM can be used to determine the crystal system of the alloy particles or magnetic particles, it is preferable to use X-ray diffraction because of its high accuracy. In order to analyze the composition of the inside of the alloy particle or magnetic particle, an FE-TEM capable of finely focusing electron beams is preferably used together with an EDAX. A VSM can be used to evaluate the magnetic property of the alloy particles or magnetic particles.

A layer including the alloy particles produced as described above is formed on a support and subsequently annealed to obtain a magnetic layer. In the present invention, the following heat treatment is provided before or after the layer including the alloy particles is formed on the support.

<Heat Treatment>

In the present invention, as described above, a reducing agent containing a boron atom is used in the formation of the alloy particles. However, the boron atom may be mixed as an impurity in the system forming the alloy particles, and it is known (See JP-A No. 2003-6830) that the transformation temperature may lower when the boron atoms are mixed in the alloy particles in an amount of 1 at % or more. Therefore, heat treatment is carried out on the alloy particles such that the content of the boron atoms in the alloy particles is decreased to 0 to 0.9 at %. By setting the content of the boron atoms within the above range, unintentional decrease in the transformation temperature is prevented, and variations in the magnetic property can be removed.

Although the temperature set in this step varies depending on the duration of the heat treatment, the temperature is below the transformation temperature and is preferably 100 to 300° C., more preferably 100 to 250° C., and particularly preferably 150 to 250° C.

Although the duration of the heat treatment varies depending on the temperature at the heat treatment, the duration is preferably 1 to 120 minutes, more preferably 5 to 60 minutes, and particularly preferably 10 to 30 minutes.

In an embodiment, the content of the boron atoms can be controlled within the above range by carrying out the heat treatment at 100 to 250° C. for 10 to 30 minutes.

Examples of preferable heating means in the heat treatment include an electric furnace, infrared heating, and hot-air blowing and the like.

As the reducing agent containing the boron atoms (eg., the compound containing BH₄⁻) used in the above-described alloy particle production, NaBH₄ may be favorably used because of its low cost. Commercially available NaBH₄ generally contains fluorine as an impurity, and the fluorine atoms are mixed in the magnetic layer when the alloy particles are produced by using NaBH₄. In the heating treatment of the present invention as well, the fluorine atoms are not removed and are mixed in the magnetic layer in an amount of 0.3 to 30 at % based on the magnetic particles. Thus, when a magnetic recording medium is produced by using NaBH₄ in accordance with the method of the invention for producing a magnetic recording medium, the contents of the boron atoms and the fluorine atoms in the magnetic layer of the magnetic recording medium fall within the above ranges.

<Oxidation>

By oxidizing thus-obtained alloy particles, magnetic particles having ferromagnetism can be efficiently produced without increasing the temperature during the subsequent annealing. The explanation is supposedly as follows:

Namely, at first, oxygen enters a crystal lattice by oxidizing the alloy particle. When the alloy particle is annealed in this state, oxygen is dissociated from the crystal lattice by the heat. Defects develop by the dissociation of oxygen. Since the metal atoms forming the alloy can easily move through the defects, phase transformation easily occurs even at a relatively low temperature.

Such a phenomenon is supported by measuring the EXAFS (expanded X-ray absorption fine structure) of the alloy particle after the oxidation and the magnetic particle after the annealing. For example, in a Fe—Pt alloy particle which has not been oxidized, a bond between Fe atoms or between a Pt atom and a Fe atom can be confirmed.

On the contrary, in an alloy particle which has been oxidized, a bond between a Fe atom and an oxygen atom can be confirmed. However, bonds between Fe atoms and between a Pt atom and a Fe atom are scarcely observed. This means that the bonds of Fe—Pt and Fe—Fe have been cut by oxygen atoms. For this reason, it is considered that Pt atoms and Fe atoms easily move during annealing. After the alloy particle is annealed, the presence of oxygen cannot be confirmed, and the presence of bonds between Fe atoms and between a Pt atom and a Fe atom can be confirmed.

Considering the above phenomenon, it can be understood that, without the oxidation, the phase transformation is difficult to proceed and the annealing temperature needs to be high. However, if the oxidation is carried out excessively, the interaction between oxygen and a metal which is easily oxidized such as Fe becomes so strong that a metal oxide is produced.

Thus, control of the oxidation state of the alloy particles is important, and for this purpose, the oxidation conditions need to be optimized.

When the alloy particles are produced by the liquid phase method described above, the oxidation can be carried out by supplying a gas including oxygen to the produced alloy-particle-containing solution. The partial pressure of the oxygen is preferably 10 to 100%, and more preferably 15 to 50%, of the total pressure.

The oxidation temperature is preferably 0 to 100° C. and more preferably 15 to 80° C.

The oxidation state of the alloy particles is preferably evaluated by the EXAFS and the like. The number of bonds between a base metal such as Fe and oxygen is preferably 0.5 to 4 and more preferably 1 to 3 from the viewpoint of cutting the Fe-Fe bonds and Pt—Fe bonds by oxygen.

Further, the alloy particles applied or fixed to the support or the like may be oxidized by exposure to air at room temperature (0 to 40° C.). Flocculation of the alloy particles can be prevented by oxidizing the alloy particles coated on the support or the like. The duration of the oxidation is preferably 1 to 48 hours, and more preferably 3 to 24 hours.

<Annealing>

As described above, since the oxidized alloy particles have a disordered phase, the particles cannot attain ferromagnetism. Therefore, in order to transform the disordered phase to the ordered phase, another heat treatment (annealing) needs to be carried out. The transformation temperature, at which the phase of the alloy forming the alloy particles transforms from the disordered phase to the ordered phase, can be obtained by using a differential thermal analyzer (DTA). The heating treatment needs to be carried out at a temperature equal to or higher than the transformation temperature.

Although the transformation temperature is generally about 500° C., it may be decreased by adding a third element. Moreover, the transformation temperature can be lowered by appropriately changing the atmosphere of the above oxidation or annealing. Thus, the annealing temperature is preferably 150° C. or higher, and more preferably 150 to 450° C.

Magnetic recording tapes and floppy disks are typical magnetic recording media. These media are manufactured by forming a magnetic layer in the form of a web on a support comprising an organic material, and subsequently processing the magnetic layer into tapes in the case of tapes or punching out the magnetic layer into disks in the case of floppy disks. Since the present invention can lower the transformation temperature at which the alloy becomes ferromagnetic, the present invention is effective when the support comprises an organic material. Therefore, the above magnetic recording media are preferable application of the present invention.

When the magnetic layer in the form of a web is annealed, the annealing time is preferably short. The reason is that a long apparatus is necessary when the annealing time is long. For example, when the conveyance speed of a web is 50 m/min and the annealing time is 30 minutes, the length of a line is as long as 1500 mm. Thus, in the method of the invention for producing a magnetic recording medium, the annealing time is preferably 10 minutes or shorter, and more preferably 5 minutes or shorter.

In order to shorten the annealing time, the atmosphere of the annealing is preferably a reducing atmosphere, as will be described later. A shorter annealing time is effective in preventing deformation of the support and diffusion of impurities therefrom.

If the alloy is annealed in the state of particles, the particles easily move to cause fusion. Therefore, although high coercive force can be obtained, the resultant magnetic recording medium tends to have a drawback of its large particle size. Accordingly, the annealing is preferably conducted on the alloy particles coated on a support, in order to prevent flocculation of the alloy particles. Further, by annealing the alloy particles on the support to form magnetic particles, a magnetic recording medium including a magnetic layer formed by the magnetic particles can be obtained.

The support may comprise an organic material or an inorganic materials. The inorganic material may be selected from Al, a Mg alloy such as an Al—Mg alloy or a Mg—Al—Zn alloy, glass, quartz, carbon, silicon, and ceramics. Supports comprising these materials have high impact resistance and also have rigidity suitable for a thinner support and high speed rotation. These supports are more resistant to heat than organic supports are.

The organic material for the support may be selected from polyesters such as polyethylene terephthalate and polyethylene naphthalate, polyolefins, cellulose triacetate, polycarbonates, polyamides (including aliphatic polyamides and aromatic polyamides such as aramide), polyimides, polyamidoimides, polysulfones, and polybenzoxazole.

In order to coat the alloy particles on the support, various additives may be added to the alloy-particle-containing solution which has been subjected to the oxidation, in accordance with the necessity. Then, the mixture is coated on the support. The content of the alloy particles in the mixture may be a desired content (for example, 0.01 to 0.1 mg/ml). In an embodiment, the magnetic layer of the magnetic recording medium includes a binder.

The method for coating the alloy particles on the support may be air doctor coating, blade coating, rod coating, extrusion coating, air knife coating, squeeze coating, impregnation coating, reverse roll coating, transfer roll coating, gravure coating, kiss coating, cast coating, spray coating, spin coating, or the like.

The atmosphere during annealing is preferably a non-oxidizing atmosphere such as H₂, N₂, Ar, He, Ne, or the like in order to efficiently promote the phase transformation and prevent oxidation of the alloy.

Particularly, in terms of dissociation of oxygen which has entered the lattice by the oxidation, the atmosphere is preferably a reducing atmosphere such as methane, ethane, or H₂. Further, in order to maintain the particle diameter constant, the annealing is preferably carried out in a magnetic field under the reducing atmosphere. When the annealing is carried out under H₂ atmosphere, an inert gas may be preferably mixed for explosion-protection.

Further, in order to prevent fusion of the particles during the annealing, it is preferable to carry out annealing once at a temperature equal to or lower than the transformation temperature in an inert gas to carbonize the dispersant, and then carry out annealing at a temperature equal to or higher than the transformation temperature in a reducing atmosphere. In an embodiment, after annealing at a temperature equal to or lower than the transformation temperature is conducted, a silicon-containing resin is applied onto the layer of the alloy particles in accordance with the necessary, and then the annealing at a temperature equal to or higher than the transformation temperature is carried out.

By carrying out such annealing as described above, the phase of the alloy particles is transformed from the disordered phase to the ordered phase, whereby magnetic particles having ferromagnetism are produced.

The coercive force of the magnetic particles produced by the above-described production method of the present invention is preferably 95.5 to 398 kA/m (1200 to 5000 Oe), and more preferably 95.5 to 278.6 kA/m (1200 to 3500 Oe), considering the adaptability of the recording head in the case of a magnetic recording medium.

Further, the magnetic particles have a particle diameter of preferably 1 to 100 nm, more preferably 3 to 20 nm, and particularly preferably 3 to 10 nm.

<<Magnetic Recording Medium>>

The magnetic recording medium of the invention is a magnetic recording medium comprising:
a support; and
a magnetic layer provided on the support, the magnetic layer containing a magnetic particle of a CuAu type or Cu₃Au type ferromagnetic ordered alloy phase,
wherein a content of boron atoms in the magnetic particle is 0 to 0.9 at %, and a content of fluorine atoms in the magnetic particle is 0.09 to 0.3 at %.

As described above, when the boron atoms are included in an amount of 1 at % or more in the alloy particles capable of forming the CuAu type or Cu₃Au type ferromagnetic ordered alloy phase, the transformation temperature lowers, apparent coercive force increases at the same annealing temperature, and variations in the magnetic property occur. Thus, a magnetic recording medium having little variation in the magnetic property can be obtained by setting the content of the boron atoms to 0 to 0.9 at %. Further, since most of the boron atoms are considered to be included as an impurity in the portion of the magnetic layer other than the alloy particles, it is considered that the boron atoms do not affect the magnetic property as long as the content thereof is 0.9 at % or less.

Further, as explained above in the description of the method for producing a magnetic recording medium of the invention, when NaBH₄ is used as the reducing agent in the production of the alloy particles, the fluorine atoms as an impurity are mixed in the magnetic particles of the magnetic layer in an amount of 0.9 to 30 at %. In other words, in the magnetic recording medium of the present invention, the fluorine atoms derived from NaBH₄ are included in the magnetic layer in an amount of 0.9 to 30 at %. Thus, when NaBH₄ is used as the reducing agent in the method of the invention and the content of the boron atoms is controlled within the above range, the magnetic recording medium of the present invention, namely, the magnetic recording medium in which the contents of the boron atoms and the fluorine atoms are within the ranges of the present invention, is obtained. Moreover, since the magnetic recording medium of the present invention can be produced by using NaBH₄, which is an inexpensive reducing agent, the production cost can be lowered, and variations in the magnetic property can be reduced.

The contents of the boron atoms and the fluorine atoms in the magnetic layer can be measured by an ESCA. Specifically, prior to the measurement, when other layers are provided on the magnetic layer of the magnetic recording medium, the layers are removed by etching (Ar sputtering) until the magnetic layer is exposed. Subsequently, the contents are measured at an accelerating voltage of 12 kV and a sample current of 10 mA.

Examples of the magnetic recording medium include magnetic tapes such as a video tape and a computer tape; and magnetic disks such as a floppy disk and a hard disk.

When the magnetic particles are produced by applying the alloy particles (alloy-particle-containing solution) onto the support and annealing the alloy particles as described above, the layer comprising the magnetic particles can be used as the magnetic layer.

Further, in another embodiment, the magnetic particles are produced by annealing the alloy particles in the state of particles rather than on the support. In this embodiment, the magnetic particles may be kneaded by an open kneader, a three-roll mill or the like and dispersed by a sand grinder or the like to prepare a coating liquid, which may be applied onto the support by a known method to thereby form a magnetic layer.

While the thickness of the resulting magnetic layer varies with the type of the magnetic recording medium applied, the thickness is preferably 5 to 500 nm, and more preferably 15 to 100 nm.

The magnetic recording medium may have other layers, if necessary, in addition to the magnetic layer. For example, in the case of a disk, the magnetic recording medium preferably includes a magnetic layer and a non-magnetic layer on the opposite side of the magnetic layer. In the case of a tape, the magnetic recording medium preferably includes a back layer on the side of the insoluble support opposite to the side having the magnetic layer.

Further, wear resistance can be improved by forming an extremely thin protection film on the magnetic layer, and sliding characteristics can be improved by applying a lubricant onto the protection film, whereby a magnetic recording medium having sufficiently high reliability can be obtained.

Examples of materials for the protection film include oxides such as silica, alumina, titania, zirconia, cobalt oxide, and nickel oxide; nitrides such as titanium nitride, silicon nitride, and boron nitride; carbides such as silicon carbide, chromium carbide, and boron carbide; and carbon such as graphite and amorphous carbon. Generally, hard amorphous carbon called diamond-like carbon is particularly preferable.

The carbon protection film has sufficient wear resistance even with a very small thickness and rarely causes seizing in a sliding member, and is thus suitable as a material for the protection film.

As a method for forming the carbon protection film, sputtering is generally used in the case of a hard disk. Further, a number of methods have been proposed for products which require continuous film formation such as video tapes, the methods using the plasma CVD, which enables a higher film formation rate. Accordingly, the method may be selected from these methods.

It has been reported that, among these methods, the plasma injection CVD (PI-CVD) method has an extremely high film formation rate and can provide an excellent carbon protection film, the carbon protection film being hard and having few pin holes (e.g., JP-A Nos. 61-130487, 63-279426 and 3-113824, the disclosures of which are incorporated herein by reference).

The carbon protection film has a Vickers hardness of preferably 1000 kg/mm² or higher, and more preferably 2000 kg/mm² or higher. Further, the carbon protection film preferably has an amorphous crystal structure and is preferably non-conductive.

When a diamond-like carbon film is used as the carbon protection film, the structure thereof can be confirmed by Raman spectroscopic analysis. Namely, when the spectrum of the diamond-like carbon film is measured, the structure thereof can be confirmed by detecting a peak at 1520 to 1560 cm⁻¹. If the structure of the carbon film is shifted from the diamond-like structure, the peak detected by the Raman spectroscopic analysis shifts from the foregoing range, and the hardness of the protection film decreases.

The raw carbon source for forming the carbon protection film may be a carbon-containing compounds. Examples thereof include alkanes such as methane, ethane, propane, and butane; alkenes such as ethylene and propylene; alkynes such as acetylene. Further, if necessary, a carrier gas such as argon and/or a gas for improving the film quality such as hydrogen and nitrogen may be added.

When the carbon protection film is thick, electromagnetic conversion characteristics and adhesion of the carbon protection film to the magnetic layer deteriorate. When the carbon protection film is thin, wear resistance is insufficient. Thus, the film thickness is preferably 2.5 to 20 nm and more preferably 5 to 10 nm.

In order to improve the adhesion between the protection film and the magnetic layer which serves as a substrate in this case, it is preferable to etch the surface of the magnetic layer previously with an inert gas or to modify the magnetic layer surface by exposing the surface to a reactive gas plasma such as oxygen.

The magnetic layer may have a multi-layer structure in order to improve the electromagnetic conversion characteristics. Further, the magnetic recording medium may have a known non-magnetic undercoating layer and/or an intermediate layer under the magnetic layer. In order to improve running durability and corrosion resistance, as described above, a lubricant or a rust-preventive agent may be applied onto the magnetic layer or the protection film. As the lubricant to be applied, known hydrocarbon lubricants, fluorine-containing lubricants, and extreme pressure additives, and the like can be used.

Examples of the hydrocarbon lubricants include carboxylic acids such as stearic acid and oleic acid; esters such as butyl stearate; sulfonic acids such as octadecylsulfonic acid; phosphoric esters such as monooctadecyl phosphate; alcohols such as stearyl alcohol and oleyl alcohol; carboxylic amides such as stearic acid amide; and amines such as stearylamine.

Examples of the fluorine-containing lubricants include lubricants obtained by substituting some or all of the alkyl groups of the above hydrocarbon lubricants with fluoroalkyl groups or perfluoropolyether groups.

Examples of the perfluoropolyether groups include perfluoromethylene oxide polymers, perfluoroethylene oxide polymers, perfluoro-n-propylene oxide polymers (CF₂CF₂CF₂O)ₙ, perfluoroisopropylene oxide polymers (CF(CF₃)CF₂O)ₙ, and copolymers thereof.

The hydrocarbon lubricant preferably has a polar functional group such as a hydroxyl group, an ester group, or a carboxyl group at a terminal of its alkyl group or inside the molecule since such a lubricant is effective in decreasing frictional force.

The molecular weight of the perfluoropolyether may be 500 to 5,000, preferably 1,000 to 3,000. When the molecular weight is less than 500, volatility is likely to be high and lubricating property is likely to be insufficient. Further, when the molecular weight exceeds 5,000, viscosity is likely to be high, whereby a slider and a disk are likely to adhere to each other and to cause stoppage of running or head crash.

As the perfluoropolyethers, FOMBLIN manufactured by Audimont K.K., KRYTOX manufactured by Du Pont K.K., and the like are commercially available.

Examples of the extreme pressure additives include phosphoric acid esters such as trilauryl phosphate; phosphorous acid esters such as trilauryl phosphite; thiophosphorous acid esters such as trilauryl trithiophosphite; thiophosphoric acid esters; and sulfur-containing extreme pressure agents such as dibenzyl disulfide.

Only a single lubricant may be used or two or more lubricants may be used in combination. The methods for applying the lubricant onto the magnetic layer or the protection film may comprise: dissolving such a lubricant in an organic solvent; and applying the solution onto the magnetic layer or the protection film by a wire bar, gravure coating, spin coating, or dip coating, or depositing the lubricant on the magnetic layer or protection film by vacuum evaporation.

Examples of the rust-preventive agents include nitrogen-containing heterocyclic compounds such as: benzotriazole, benzimidazole, purine, and pyrimidine; derivaties thereof obtained by introducing alkyl side chains into the mother moieties of these compounds; nitrogen-containing heterocyclic compounds and sulfur-containing heterocyclic compounds such as benzothiazole, 2-mercaptobenzothiazole, tetrazaindene cyclic compounds, and thiouracyl compounds; and derivatives thereof.

As described above, when the magnetic recording medium is a magnetic tape, the magnetic recording medium may include a back coat layer (a backing layer) provided on the side of the non-magnetic support opposite to the magnetic layer side. The back coat layer is a layer formed by applying a coating liquid for forming the back coat layer onto the surface of the non-magnetic support, the surface being on the opposite side to the magnetic layer side. The coating liquid is prepared by dispersing granular components such as abrasives and anti-static agents and binders in a known organic solvent.

Examples of the granular components include various types of inorganic pigments and carbon black. Examples of the binders include nitrocellulose, phenoxy resins, vinyl chloride resins, and polyurethane resins. Only a single kind of binder may be used, or two or more kinds of binders may be used in combination.

In an embodiment, the alloy-particle-containing solution is coated on a known adhesive layer provided on the substrate. Similarly, the back coat layer may be provided on a known adhesive layer provided on the substrate.

The magnetic recording medium produced as described above has a center-line average roughness of the surface at a cut-off value of 0.25 in a range of preferably 0.1 to 5 nm and more preferably 1 to 4 nm. When the center line average roughness is in the above range, the magnetic recording medium has a surface with excellent smoothness, thus the magnetic recording medium is suitable for high density recording.

An example of the method for obtaining such a surface is a method comprising subjecting the magnetic recording medium to a calendering treatment after the magnetic layer is formed. In an embodiment, varnishing treatment is conducted.

The obtained magnetic recording medium may be properly punched out by a punching machine, or cut into a desired size by a cutting machine, and used.

### EXAMPLES

The present invention will now be described with reference to Examples. However, the Examples should not be construed as limiting the invention.

### Example 1

Production of FePt Alloy Particles

The following operations were carried out in high purity N₂ gas.

An alkane solution obtained by mixing 10.8 g of AEROSOL OT (produced by Wako Pure Chemical Industries, Ltd.), 80 ml of decane (produced by Wako Pure Chemical Industries, Ltd.), and 2 ml of oleylamine (produced by Tokyo Kasei Kogyo Co., Ltd.) was added to and mixed with an aqueous reducing agent solution obtained by dissolving 0.76 g of NaBH₄ (produced by Wako Pure Chemical Industries, Ltd.) in 16 ml of water (deoxygenized: 0.1 ml/liter or less) to prepare a reverse micelle solution (I).

An alkane solution obtained by mixing 5.4 g of AEROSOL OT and 40 ml of decane was added to and mixed with an aqueous metal salt solution obtained by dissolving 0.46 g of iron triammonium trioxalate (Fe(NH₄)₃(C₂O₄)₃) (produced by Wako Pure Chemical Industries, Ltd.) and 0.38 g of potassium chloroplatinate (K₂PtCl₄) (produced by Wako Pure Chemical Industries, Ltd.) in 12 ml of water (deoxygenized) to prepare a reverse micelle solution (II).

The reverse micelle solution (II) was added in an instant to the reverse micelle solution (I) while the reverse micelle solution (I) was stirred at 22° C. at a high speed by an Omni mixer (manufactured by Yamato Scientific Co., Ltd.). 10 minutes later, the resulting mixture was heated to 50° C. while being stirred by a magnetic stirrer and then matured for 60 minutes.

2 ml of oleic acid (produced by Wako Pure Chemical Industries, Ltd.) was added to the mixture, and the mixture was cooled to room temperature. After the cooling, the mixture was taken out to the atmosphere. In order to break reverse micelles, a mixed solution obtained by mixing 100 ml of water and 100 ml of methanol, was added to the mixture, and a water phase and an oil phase separated, wherein alloy particles dispersed in the oil phase. The oil phase was washed five times with a mixed solution obtained by mixing 600 ml of water and 200 ml of methanol.

Thereafter, 1100 ml of methanol was added to the resulting liquid to flocculate and precipitate the alloy particles. The supernatant was removed, and 20 ml of heptane (produced by Wako Pure Chemical Industries, Ltd.) was added to the residue to disperse the particles again.

Further, the precipitation treatment of adding 100 ml of methanol and dispersing treatment of dispersing the precipitate in 20 ml of heptane were repeated twice. Finally, 5 ml of heptane was added to prepare a alloy-particle-containing solution including FePt alloy particles with a mass ratio (water/surfactant) of 2.

The yield, the composition, the volume mean diameter, and the distribution (variation coefficient) of the alloy particles obtained as described above were measured, and the results as shown below were obtained. The composition and the yield were measured by ICP spectroscopic analysis (inductively coupled high frequency plasma spectroscopic analysis). The volume mean diameter and the distribution were calculated by measuring the particles photographed by a TEM (transmission electron microscope, manufactured by Hitachi Ltd., 30 kV) and processing the measurement results statistically.

The alloy particles for measurement were collected from the prepared alloy-particle-containing solution, sufficiently dried, and heated in an electric furnace, then used for the measurements.
Composition: FePt alloy including 44.5 at % of Pt
Yield: 85%
Mean particle diameter: 4.2 nm
Variation coefficient: 5%
   Formation of Alloy Particle Layer

The alloy particles were degassed in vacuum to remove a solvent therefrom, and decane was added to the alloy particles in the air to obtain a dispersion including 4% by mass of the alloy particles. A 1% solution of silicone resin (R910 produced by Toray Industries, Inc.,; the solvent was decane) was added to the dispersion in an amount of 81.6 μl per ml of the dispersion, so as to obtain a coating liquid.

The coating liquid was applied onto a glass substrate for a hard disk (65/20-0.635t polished glass substrate manufactured by Toyo Kohan Co., Ltd.) by a spin coater to form an alloy particle layer. Subsequently, heat treatment was carried out on the alloy particle layer in the air at 200° C. for 60 minutes by using a drier manufactured by ISUZU MFG. CO., LTD (the heat treatment including the oxidation).

Formation of Magnetic Layer

Annealing was conducted as described below. The alloy particle layer was heated in an electric furnace under an atmosphere of mixed gas (H₂:Ar=5:95) at a temperature rising rate of 200° C./min until the temperature becomes 450° C., then the furnace temperature was maintained at 450° C. for 30 minutes, then cooled to room temperature at a temperature decreasing rate of 50° C./min, so that a magnetic layer was formed. The magnetic layer had a thickness of 20 nm, and the variation coefficient of the layer thickness was 25%.

### Example 2

A magnetic recording medium of Example 2 was produced in the same way as in Example 1 except that the heat treatment time in the “formation of alloy particle layer” section in Example 1 was changed to the heat treatment time shown in Table 1.

### Example 3

Production of FePtCu Alloy Particles

The following operations were carried out in high purity N₂ gas.

An alkane solution obtained by dissolving 5.4 g of AEROSOL OT (produced by Wako Pure Chemical Industries, Ltd.) and 2 ml of oleylamine (produced by Tokyo Kasei Kogyo Co., Ltd.) in 40 ml of decane (produced by Wako Pure Chemical Industries, Ltd.) was added to and mixed with an aqueous reducing agent solution obtained by dissolving 0.57 g of NaBH₄ (produced by Wako Pure Chemical Industries, Ltd.) in 12 ml of H₂O (deoxygenized) to prepare a reverse micelle solution (III).

An alkane solution obtained by dissolving 10.8 g of AEROSOL OT in 80 ml of decane was added to and mixed with an aqueous metal salt solution obtained by dissolving 0.35 g of iron triammonium trioxalate (Fe(NH₄)₃(C₂O₄)₃) (produced by Wako Pure Chemical Industries, Ltd.) and 0.35 g of potassium chloroplatinate (K₂PtCl₄) (produced by Wako Pure Chemical Industries, Ltd.) in 24 ml of H₂O (deoxygenized) to prepare a reverse micelle solution (IV).

An alkane solution obtained by dissolving 5.4 g of AEROSOL OT (produced by Wako Pure Chemical Industries, Ltd.) in 40 ml of decane (produced by Wako Pure Chemical Industries, Ltd.), was added to and mixed with an aqueous reducing agent solution obtained by dissolving 0.88 g of ascorbic acid (produced by Wako Pure Chemical Industries, Ltd.) in 12 ml of H₂O (deoxygenized) to prepare a reverse micelle solution (III′).

An alkane solution obtained by dissolving 2.7 g of AEROSOL OT in 20 ml of decane was added to and mixed with an aqueous metal salt solution obtained by dissolving 0.07 g of copper chloride (CuCl₂.6H₂O) (produced by Wako Pure Chemical Industries, Ltd.) in 2 ml of H₂O (deoxygenized) to prepare a reverse micelle solution (IV′).

The reverse micelle solution (IV) was added in an instant to the reverse micelle solution (III) while the reverse micelle solution (III) was stirred at 22° C. at a high speed by an Omni mixer (manufactured by Yamato Scientific Co., Ltd.). Three minutes later, the reverse micelle solution (III′) was added to the resulting mixture over about 10 minutes at a rate of about 2.4 ml/min. Five minutes after the addition of the reverse micelle solution (III′), the resulting mixture was heated to 40° C. while being stirred by a magnetic stirrer. Then, the reverse micelle solution (IV′) was added, and the resulting mixture was matured for 120 minutes. After the mixture was cooled to room temperature, 2 ml of oleic acid (produced by Wako Pure Chemical Industries, Ltd.) was added to and mixed with the mixture, and the mixture was taken out to the atmosphere. In order to break reverse micelles, a mixed solution obtained by mixing 200 ml of H₂O and 200 ml of methanol was added to the mixture, and a water phase and an oil phase separated, wherein alloy nano-particles dispersed in the oil phase. The oil phase was washed five times with 600 ml of H₂O and 200 ml of methanol. Thereafter, 1300 ml of methanol was added to the resulting solution to flocculate and precipitate the alloy particles. The supernatant was removed, and 20 ml of heptane (produced by Wako Pure Chemical Industries, Ltd.) was added to the residue to disperse the particles again. Further, precipitation treatment of adding 100 ml of methanol and dispersing treatment of dispersing the precipitate in 20 ml of heptane were repeated twice. Finally, 5 ml of octane (produced by Wako Pure Chemical Industries, Ltd.) was added, so that an FeCuPt alloy-particle-containing solution was obtained. (the formation of the alloy particle)

Formation of Alloy Particle Layer

The alloy particles were degassed in vacuum to remove a solvent therefrom, and decane was added to the alloy particles in the air to obtain a dispersion including 4% by mass of alloy particles. A 1% solution of silicone resin (R910 produced by Toray Industries, Inc., ; the solvent was decane) was added to the dispersion in an amount of 81.6 μl per ml of the dispersion, so as to give a coating liquid.

The coating liquid was applied onto a glass substrate for a hard disk (65/20-0.635t polished glass substrate manufactured by Toyo Kohan Co., Ltd.) by a spin coater. Subsequently, heat treatment was carried out on the alloy particle layer in the air at 200° C. for 60 minutes by using the drier manufactured by ISUZU MFG. CO., LTD (the heat treatment including the oxidation).

Formation of Magnetic Layer

Annealing was conducted as described below. The alloy particle layer was heated in an electric furnace under an atmosphere of mixed gas (H₂:Ar=5:95) at a temperature rising rate of 200° C./min until the temperature becomes 450° C., then the furnace temperature was maintained at 450° C. for 30 minutes, then cooled to room temperature at a temperature decreasing rate of 50° C./min, so that a magnetic layer was formed. The magnetic layer had a thickness of 20 nm, and the variation coefficient of the layer thickness was 25%.

### Example 4

A magnetic recording medium of Example 4 was produced in the same way as in Example 3 except that the heat treatment time in the “formation of alloy particle layer” section in Example 3 was changed to the heat treatment time shown in Table 1.

### Comparative Example 1

A magnetic recording medium of Comparative Example 1 was produced in the same way as in Example 1 except that the heat treatment described in the “formation of alloy particle layer” section in Example 1 was not conducted.

### Comparative Example 2

A magnetic recording medium of Comparative Example 2 was produced in the same way as in Example 3 except that the heat treatment described in the “formation of alloy particle layer” section in Example 3 was not conducted.

Evaluation

1. Measurement of Contents of Boron Atoms and Fluorine Atoms

The composition of the surface of the magnetic layer of each of the magnetic recording media obtained in Examples 1 to 4 and Comparative Examples 1 and 2, was analyzed by an ESCA (ESCA-3400 manufactured by Shimadzu Corporation and KRATOS ANALYTICAL Ltd.) under the following conditions. The results are shown in Table 1.

Conditions for Measurement with ESCA

After contamination on the surface of the magnetic layer was removed by Ar sputtering, the composition of the surface was measured under conditions of an accelerating voltage of 12 kV and a sample current of 10 mA.

2. Measurement of Coercive Force

The magnetic property (i.e., coercive force) of each of the magnetic recording media obtained in Examples 1 to 4 and Comparative Examples 1 and 2 was measured. Specifically, the magnetic layer on the substrate was evaluated by a sensitive magnetization vector measuring apparatus and a DATA processing apparatus (both manufactured by Toei Industry Co., Ltd.) under a condition of an applied magnetic field of 790 kA/m (10 kOe).

TABLE 1

| | | Heat | Boron | Fluorine | Coercive |
|---|---|---|---|---|---|
| | Magnetic | treatment | content | content | force Hc |
| | particles | time (min) | (at %) | (at %) | (kA/m) |
| Example 1 | FePt | 60 | Undetected | 5 | 238.9 |
| Example 2 | FePt | 10 | 0.7 | 7 | 246.8 |
| Example 3 | FePtCu | 60 | Undetected | 8 | 382.2 |
| Example 4 | FePtCu | 10 | 0.6 | 7 | 374.2 |
| Comparative | FePt | None | 4 | 5 | 200 |
| Example 1 | | | | | |
| Comparative | FePtCu | NoneI | 7 | 6 | 220 |
| Example 2 | | | | | |

According to Table 1, in the magnetic recording media of Examples 1 to 4, the contents of the boron atoms and the fluorine atoms fell in the ranges of the present invention owing to the heat treatment. In contrast, in the magnetic recording media of Comparative Examples 1 and 2, the contents of the boron atoms and the fluorine atoms were outside the ranges of the present invention. Further, the magnetic recording media obtained in Examples 1 to 4 had stable magnetic property and higher coercive force than the recording media of Comparative Examples 1 and 2.

As described above, the present invention can provide a magnetic recording medium having stable magnetic property, and a method for producing the same.

1. A magnetic recording medium comprising:
a support; and
a magnetic layer provided on the support, the magnetic layer containing a magnetic particle of a CuAu type or Cu3Au type ferromagnetic ordered alloy phase,
wherein a content of boron in the magnetic particle is 0 to 0.9 at %, and a content of fluorine in the magnetic particle is 0.09 to 0.3 at %.

2. The magnetic recording medium according to claim 1, wherein the magnetic particle has been reduced by using NaBH₄.

3. The magnetic recording medium according to claim 1, wherein the magnetic layer further includes a binder.

4. A method for producing a magnetic recording medium, the method comprising:
forming an alloy particle capable of forming a CuAu type or Cu₃Au type ferromagnetic ordered alloy phase by a reduction method in which a reducing agent containing a boron atom is used;
forming a layer including the alloy particle on a support;
heat-treating the alloy particle at a temperature below a transformation temperature of the alloy particle; and
annealing the alloy particle at a temperature which is not lower than the transformation temperature of the alloy particle,
wherein the annealing and the heat treatment are each independently before of after the formation of the layer including the alloy particle provided that the annealing is conducted after the heat-treatment.

5. The method for producing a magnetic recording medium according to claim 4, wherein the temperature at the heat treatment is 100° C. to 300° C.

6. The method for producing a magnetic recording medium according to claim 4, wherein the temperature at the heat treatment is 100° C. to 250° C.

7. The method for producing a magnetic recording medium according to claim 5, wherein a duration of the heat treatment is 1 to 120 minutes.

8. The method for producing a magnetic recording medium according to claim 5, wherein a duration of the heat treatment is 10 to 30 minutes.

9. The method for producing a magnetic recording medium according to claim 4, wherein an electric furnace, infrared heating, or hot-air blowing is used in the heat treatment.

10. The method for producing a magnetic recording medium according to claim 4, wherein the alloy particle is oxidized between the heat treatment and the annealing.

11. The method for producing a magnetic recording medium according to claim 5, wherein the alloy particle is oxidized between the heat treatment and the annealing.

12. The method for producing a magnetic recording medium according to claim 4, wherein the substrate is an organic substrate.

13. The method for producing a magnetic recording medium according to claim 4, wherein the substrate is an inorganic substrate.

14. The method for producing a magnetic recording medium according to claim 5, wherein the substrate is an organic substrate.

15. The method for producing a magnetic recording medium according to claim 5, wherein the substrate is an inorganic substrate.

16. The method for producing a magnetic recording medium according to claim 4, wherein the reducing agent containing a boron atom is NaBH₄.

17. The method for producing a magnetic recording medium according to claim 5, wherein the reducing agent containing a boron atom is NaBH₄.

18. The method for producing a magnetic recording medium according to claim 7, wherein the reducing agent containing a boron atom is NaBH₄.

19. The method for producing a magnetic recording medium according to claim 4, wherein the layer including the alloy particle further includes a binder.

20. A magnetic recording medium produced by the method of claim 4.
